(19) United States
(12) Patent Application Publication
(10) Pub. No.: US 2023/0033129 A1
(43) Pub. Date: Feb. 2, 2023

(54) VEHICLE SUPPORT DEVICE AND ITS PRODUCTION METHOD

(71) Applicant: QING XU, Foshan (CN)

(72) Inventor: QING XU, Foshan (CN)

(21) Appl. No.: 17/407,118

(22) Filed: Aug. 19, 2021

(30) Foreign Application Priority Data
Aug. 2, 2021 (CN) 202110882260.6

(51) Int. Cl. B66F 3/12

(52) U.S. Cl. CPC B66F 3/12

(57) ABSTRACT

A production method of a vehicle support device including: making a symmetrical thread structure by pressing on both sides of a round steel, to obtain a twin-screw rod; making a through hole in the steel block which the twin-screw rod can go through, and making internal threads in the through hole that match with the twin-screw rod by stamping to obtain an adjusting block; rotating the two adjusting blocks respectively along the ends of the twin-screw rod to the middle of the same so that the two adjusting blocks are mounted onto both sides of the twin-screw rod; making a movable frame, and fixing it with two adjusting blocks; and making a spanner and fixing it to one end or the middle of the twin-screw rod.

### TECHNICAL FIELD

The present invention relates to the technical field of automobile parts, in particular to a vehicle support device and its production method.

### BACKGROUND ART

A vehicle support device consists of a jack, wheel retainers, etc. The jack is mainly used to support the vehicle body when a vehicle is under maintenance. Wheel retainers are used to fix the wheels of a stationary vehicle to avoid any accident caused by wheel rolling during the vehicle being stationary.

At present, the prior vehicle support device needs rotation of the screw when it is in use, to drive the vehicle support device to achieve horizontal or longitudinal deployment, so that the vehicle body or the wheels are supported and fixed. However, the deployment speed of the prior vehicle support device is slow, and it often takes a long time in the rotation of the screw rod, that means, the prior vehicle support device is of low efficiency during deployment, which will cause inconvenience during use.

Therefore, the prior vehicle support device has a technical problem of low efficiency in the process of deployment.

### SUMMARY OF THE INVENTION

The present invention provides a vehicle support device and its production method, which belongs to the technical field of automotive parts and solves the technical problem of low efficiency of the prior vehicle support device in the deployment process.

On the first hand, the production method of the vehicle support device includes:
making a symmetrical thread structure by pressing on both sides of a round steel to obtain a twin-screw rod;
making a through hole in a steel block so that the twin-screw rod can go through, and making internal threads matching with the twin-screw rod by pressing to obtain an adjusting block;
rotating the two adjusting blocks along both ends of the twin-screw rod to the middle of the same, so that the two adjusting blocks are mounted onto both sides of the twin-screw rod; making a movable frame, and fixing it with two adjusting blocks; and
making a spanner, and fixing it to one end or the middle of the twin-screw rod.

Further, the steps of making a symmetrical thread structure by pressing on both sides of a round steel to obtain a twin-screw rod include:
using a rotary clamping arm to hold the middle of the round steel by clamping, and feeding the round steel into the pressing machine gradually along the direction from the end of one side of the round steel to the holding position, to complete the pressing of the forward threads on one side of the round steel; and
   using the rotary clamping arm to take the round steel to raise and rotate by 180°, and then feeding the round steel gradually into the pressing machine along the direction from the holding position on the other side to the end of the other side, to complete the pressing of the backward threads on the other side of the round steel to obtain a twin-screw rod.

Further, the steps of rotating the two adjusting blocks along both ends of the twin-screw rod to the middle of the same, so that the two adjusting blocks are mounted onto both sides of the twin-screw rod include:

placing the twin-screw rod on a fixing clamp, and using the two rotary clamps on both sides of the fixing clamp to hold the adjusting blocks respectively, and making the two rotary frames move to both sides of the twin-screw rod and rotate at the same time.

Further, the steps of making a movable frame, and fixing the movable frame with two adjusting blocks include:
making an X-shaped shaft-coupling frame and an articulated frame, of which the X-shaped shaft-coupling frame includes an X-shaped shaft-coupling end in the middle and four movable shanks on both sides of the X-shaped shaft-coupling end; and the articulated frame includes an articulated end and two movable ends on both sides of the articulated end; and
fixing the articulated ends of the two articulated frames respectively with the two adjusting blocks, and connecting the two movable ends of each articulated frame with the two movable shanks on the same side of the X-shaped shaft-coupling frame.

Further, the steps after fixing the articulated ends of the two articulated frames respectively with the two adjusting blocks, and connecting the two movable ends of each articulated frame with the two movable shanks on the same side of the X-shaped shaft-coupling frame include: making a pressing plate, and pivotally connecting it to the four movable shanks of the X-shaped shaft-coupling frame through screws.

Further, the steps of making a movable frame, and fixing it with the two adjusting blocks include:

making a movable prismatic frame, which comprises two horizontally-articulated ends and two longitudinally-articulated ends, and fixing the two horizontally-articulated ends with the two adjusting blocks respectively.

Further, the steps after making a prismatic frame, which comprises two horizontal articulated ends and two longitudinal articulated ends, and fixing the two horizontal hinged ends with the two adjusting blocks respectively, include:

making a pressing plate, and pivotally connecting it to the two longitudinally-articulated ends of the movable prismatic frame through screws.

Further, the steps after making a movable prismatic frame, which comprises two horizontally-articulated ends and two longitudinally-articulated ends, and fixing the two horizontally-articulated ends with the two adjusting blocks respectively, include:
making a base component and a support component, and fixing the base component onto the longitudinally-articulated end at the bottom of the movable prismatic frame, and the support component onto the longitudinally-articulated end at the top of the movable prismatic frame.

Further, the steps of making the pressing plate, include:
making a plate component by pressing, and performing arc pressing onto the plate component to obtain a curved plate component;
bending both sides of the curved plate component by 90° to obtain a bent curved plate component; and
making anti-skid bulges on the curved plate component by pressing to obtain a pressing plate.

On the second hand, the present invention also provides a vehicle support device produced with the production method of the vehicle support device.

The production method of the vehicle support device provided by the present invention includes making a symmetrical thread structure on both sides of the round steel respectively by pressing to obtain a twin-screw rod; making a through hole in the steel block so that the twin-screw rod can pass through, and making internal threads matching with the twin-screw rod by pressing in the through hole to obtain an adjusting block; rotating the two adjusting blocks along the ends of the twin-screw rod to the middle of the same respectively, so that the two adjusting blocks are mounted onto both sides of the twin-screw rod; making a movable frame, and fixing it with the two adjusting blocks; and making a spanner, and fixing it to one end or the middle of the twin-screw rod.

With the production method of the vehicle support device provided by the present invention, a symmetrical thread structure is made on both sides of the round steel suppress respectively, to obtain a twin-screw rod; a screw structure is made by pressing respectively on the internal wall of the through hole of the two adjusting blocks, which matches with the twin-screw rod, and mounted on both sides of the twin-screw rod; the two adjusting blocks are fixed with the movable frame. Of the vehicle support device produced with the said method, the adjusting blocks on both sides can move to the middle or both ends simultaneously along the twin-screw rod in the rotation process of the twin-screw rod, so that the vehicle support device can be rapidly deployed or contracted, thereby effectively solving the problem of low efficiency of the vehicle support device in the deployment process.

Accordingly, a vehicle support device provided by the present invention also has the above-mentioned technical effects.

### BRIEF DESCRIPTION OF THE DRAWINGS

In order to describe the preferred embodiments of the present invention or the technical proposal of the prior technology more clearly, the drawings required to use in the description of the preferred embodiments and the prior art are introduced below. It is obvious that the drawings described below are embodiments of the present invention, on which other drawings may be made available, without any creative effort, to common technical staff in the field.

FIG. 1 is a schematic diagram of the vehicle support device provided in Embodiment 1 of the present invention;

FIG. 2 is a schematic diagram of the twin-screw rod in Embodiment 1 of the present invention;

FIG. 3 is a schematic diagram of the movable frame in Embodiment 1 of the present invention;

FIG. 4 is a schematic diagram of the pressing plate in Embodiment 1 of the present invention;

FIG. 5 is a schematic diagram of the spanner in Embodiment 1 of the present invention;

FIG. 6 is a schematic diagram of the movable frame in Embodiment 2 of the present invention;

FIG. 7 is a schematic diagram of the vehicle support device provided in Embodiment 2 of the present invention;

FIG. 8 is a schematic diagram of the vehicle support device provided in Embodiment 3 of the present invention.

### DESCRIPTION OF THE PREFERRED EMBODIMENTS

To further clarify the purpose, technical scheme and advantages of the present invention, a clear and complete description of the technical scheme of the present invention is given below in combination with the attached drawings. Obviously, the described embodiments are part but not all of the embodiments of the present invention. On the basis of the embodiments of the present invention, all other embodiments obtained by common technical staff in the field without having performed creative labor are covered by the protection of the present invention.

The terms "including" and "having", and any variation thereof, referred to in embodiments of the present invention are intended to cover non-exclusive inclusion. For example, a process, method, system, product, or equipment consisting of a series of steps or units is not limited to the listed steps or units, but optionally includes other steps or units that are not listed, or optionally includes other steps or units that are inherent to such process, method, product, or equipment.

At present, the prior vehicle support device needs rotation of the screw rod when it is used, to drive the vehicle support device to achieve horizontal or longitudinal deployment, so that the vehicle body or the wheels are supported and fixed. However, the deployment speed of the prior vehicle support device is slow, and it often takes a long time in the rotation of the screw rod, that means, the prior vehicle support device is of low efficiency during deployment, which causes inconvenience during use.

Therefore, the prior vehicle support device has a technical problem of low efficiency in the deployment process.

To solve this problem, a production method of a vehicle support device is provided in the embodiments of the present invention.

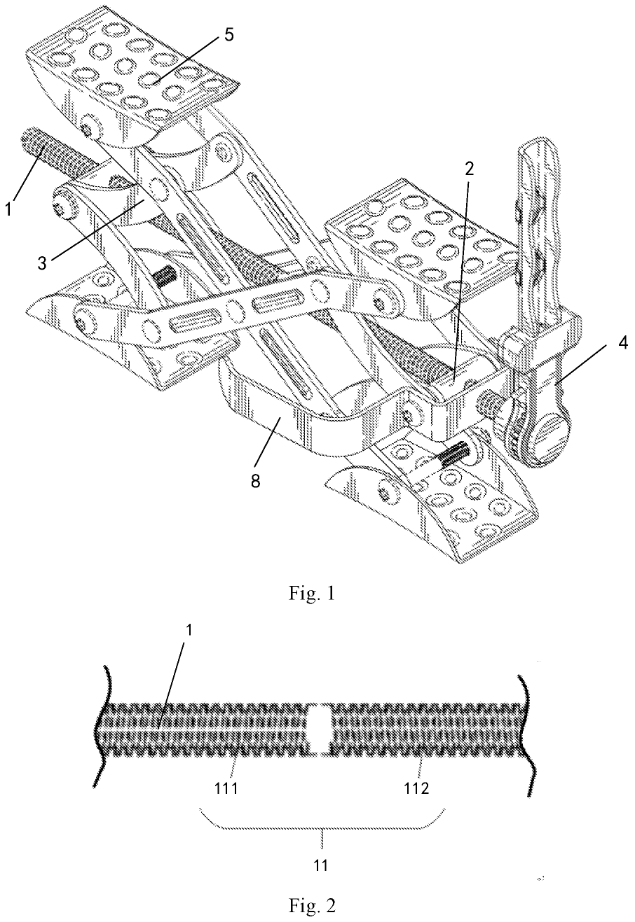

As shown in FIG. 1 and FIG. 2, the production method of the vehicle support device provided by the embodiments of the present invention includes making a symmetrical thread structure 11 on both sides of a round steel by pressing respectively to form a twin-screw rod 1; making a through hole in the steel block which the twin-screw can go through, and making internal threads matching the twin-screw rod 1 in the through hole to form an adjusting block 2; rotating the two adjusting blocks 2 to the middle of the twin-screw rod 1 along the twin-screw rod 1 from its both ends, so that the two adjusting blocks 2 are mounted onto both sides of the twin-screw rod 1; making a movable frame 3, and fixing the movable frame 3 with the two adjusting blocks 2; and making a spanner 4 and fixing spanner 4 onto one end or the middle of twin-screw rod 1.

The production method of the vehicle support device provided by the embodiments of the present invention includes making a symmetrical thread structure 11 on both sides of a round steel by pressing respectively to form a twin-screw rod 1; making a symmetrical thread structure 11 matching the twin-screw rod 1 in the internal walls of the through hole of the two adjusting blocks 2 and mounting the two adjusting blocks on both sides of the twin-screw rod 1, and fixing the two adjusting blocks 2 with the movable frame 3. Of the vehicle support device produced with this method, the adjusting blocks 2 on both sides can move to the middle or both ends simultaneously along the twin-screw rod during the rotation of the twin-screw rod, so that the vehicle support device can achieve quick deployment or contraction, thereby effectively solving the problem of low efficiency of the prior vehicle support device in the deployment process.

In one of possible preferred embodiments, the steps of making a symmetrical thread structure 11 on both sides of a round steel respectively to form a twin-screw rod 1 include: holding the middle of the round steel by rotating the clamping arm, and feeding the round steel into the pressing machine gradually along the direction from the end of one side of the round steel to the clamping position, to complete the pressing of the forward threads 111; feeding the round steel from along the direction near the holding position on the other side to the end on the other side by rotating the clamping arm to drive the round steel to raise and rotate by 180°, to complete the pressing of backward threads on the other side of the round steel, to obtain a twin-screw rod 1. In the process of feeding the round steel into the pressing machine by using the rotary clamping arm, no manual operation is required, which improves the production efficiency, saves the labor cost and improves the safety of the pressing operation.

In one of possible embodiments, the steps of rotating the two adjusting blocks 2 to the middle of the twin-screw rod 1 from its both ends along the twin-screw 1 respectively, so that the two adjusting blocks 2 are mounted onto both sides of the twin-screw 1, include: placing the twin-screw rod 1 onto the fixing clamp, holding the adjusting blocks 2 respectively by using the two rotary clamps located on both sides of the fixing clamp, and making the two rotary frames move to both sides of the twin-screw rod simultaneously, and rotate. The two adjusting blocks 1 may be mounted onto the twin-screw rod 1 at the same time through the combined action of the rotary clamp and the fixing clamp, which improves the mounting efficiency and saves the labor cost.

### Embodiment 1

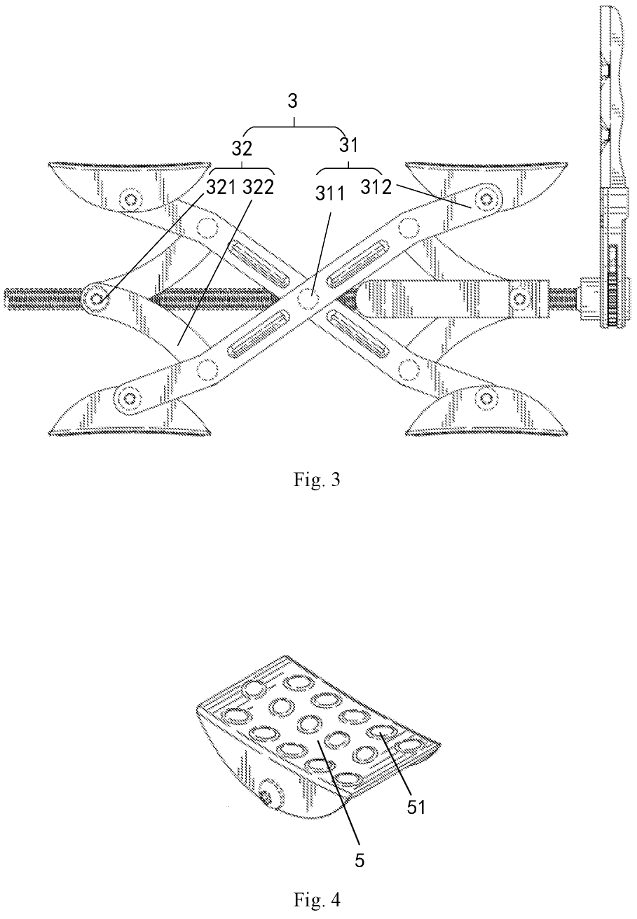

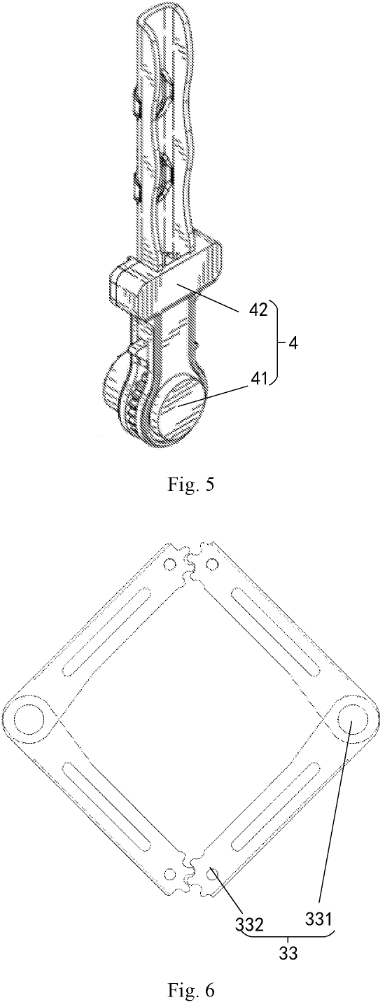

In one of possible embodiments, as shown in FIG. 3, the steps of making a movable frame 3 include: making an X-shaped shaft-coupling frame 31 and an articulated frame 32, in which the X-shaped shaft-coupling frame 31 comprises an X-shaped shaft-coupling end 311 located in the middle and four movable shanks 312 located on both sides of the X-shaped shaft-coupling end 311; the articulated frame 32 comprises an articulated end 321 and two movable ends 322 on both sides of the articulated end 321; fixing the articulated end 321 of the two articulated frames 32 with the two adjusting blocks 2 respectively, and connecting the two movable ends 322 of each articulated frame 32 respectively with the two movable shanks 312 located on the same side of the X-shaped shaft-coupling frame 31. The X-shaped shaft-coupling articulated frame 31 and the connecting frame are connected by bolts, so that the X-shaped shaft-coupling frame 31 matches with the connecting frame, thereby achieving deploying or contraction in the mutual movement of the two adjusting blocks 2.

In one of possible embodiments, the steps after making the movable frame 3 include: making the pressing plate 5, pivotally connecting the pressing plate 5 to the four movable shanks 312 of the X-shaped shaft-coupling frame 31 through screws, and mounting the pressing plate 5 on the four movable shanks 312, and then the vehicle wheels may be fixed using the pressing plate 5.

In one of one of possible embodiments, the specific steps of making the pressing plate 5 as shown in FIG. 4 include: making a plate component by pressing, in which, arc pressing is performed on the plate component to obtain a pressed curved plate component; bending both sides of the curved plate component by 90° to form a bent curved plate component; and making anti-skid bulges 51 on the curved plate component by pressing to obtain a pressing plate 5. The pressing plate 5 component is of circular plate, and there are through holes on its both sides used for connection, which makes it easy to mount the pressing plate 5, and to bend both sides of the curved plate component, so that the bent part can be connected with the movable frame 3. The anti-skid bulges 51 are made to increase the friction between the pressing plate 5 and the vehicle wheels, thus improving the fixing effect of the vehicle wheels, and preventing the pressing plate 5 from skidding on the wheel.

In one of possible embodiments, the steps of making the spanner 4 as shown in FIG. 4 include: making a one-way rotating component 41 and a folding handle component 42; pivotally connecting the one-way rotating component 41 and the folding handle component 42, to form a folding spanner 4 and then setting the folding spanner 4. To use the folding spanner 4, it is only required to unfold the folding spanner 4, and fold the folding handle after the use is ended, which makes the transportation and storage of the vehicle support device easier, saving space.

In one of possible embodiments, this method also includes: making a fixing hand rail 8, and fixing it onto the movable frame 3 through bolts. In the process of operating the spanner 4, the fixing hand rail 8 is used to control the stability of the vehicle support device, and the setting of the fixing hand rail 8 also makes it easy to hold the vehicle support device by hand, facilitating any moving operation.

### Embodiment 2

In one of possible embodiments, the steps of making a movable frame as shown in FIG. 6 include: making a movable prismatic frame 33, which comprises two horizontally-articulated ends 331 and two longitudinally-articulated ends 332 and each of such longitudinally-articulated end 332 has two articulating points, and fixing the horizontally-articulated ends 331 of the movable prismatic frame 33 with the two adjusting blocks respectively. The movable prismatic frame 33 is articulated. When the screw rod is rotating, the adjusting block 2 drives the two horizontally-articulated ends of the movable prismatic frame 33 to move inward or outward at the same time, so that the movable prismatic frame 33 can be opened and closed horizontally or longitudinally, thereby driving the vehicle support device to unfold or contract rapidly.

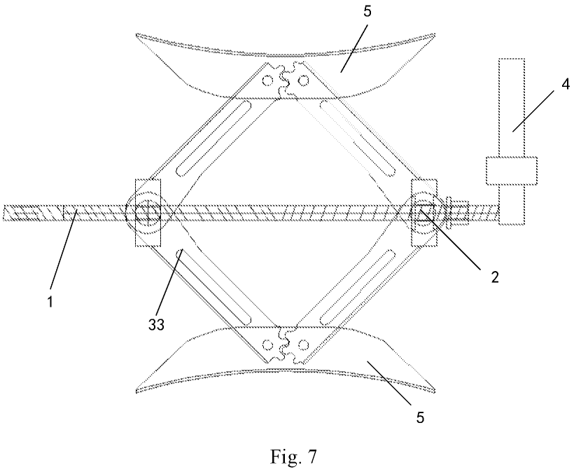

In one of possible embodiments, the steps after making a movable prismatic frame as shown in FIG. 7 include: making a pressing plate 5, and pivotally connecting the pressing plate 5 onto the two longitudinally-articulated ends 332 of the movable prismatic frame 33 through screws. The two longitudinal pressing plates 5 forming by pivotally connecting the pressing plate 5 onto the two longitudinally-articulated ends 332 of the movable prismatic frame 33 can squeeze and fix the two adjacent tires in the process of use.

### Embodiment 3

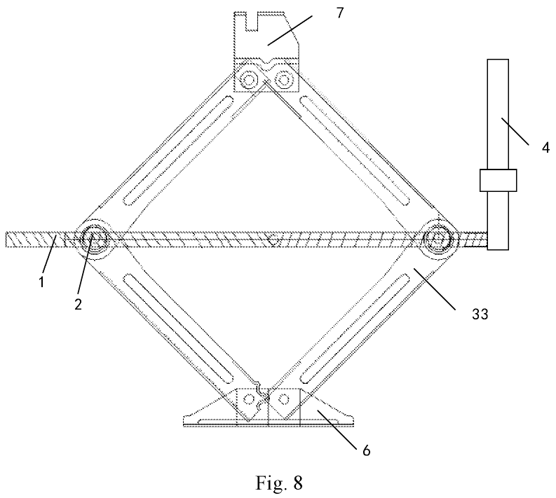

In one of possible embodiments, the steps after making the movable prismatic frame 33 as s shown in FIG. 6 and FIG. 8, include: making a base component 6 and a support component 7, fixing the base component 6 onto the longitudinally-articulated end 332 at the bottom of the prismatic movable frame 33, and fixing the support component 7 onto the longitudinally-articulated end 332 at the top of the prismatic movable frame 33 to form a jack. During use, place the base on the ground, and use the spanner 4 to rotate the twin-screw rod 1, so that the adjusting block 2 to drive the prismatic frame to deploy quickly, and the support component 7 at the top to gradually rise, thereby playing a support role on the vehicle body.

The embodiments of the present invention also provide a vehicle support device produced with the production method of a vehicle support device provided by the above embodiments. The vehicle support device produced by the above method has the advantage of high deploying or contraction efficiency, thus improving the convenience of the product in the use process.

It should be noted that similar numbers and letters represent similar terms in the drawings below. Therefore, once a term is defined in one drawing, there is no need to define or explain it further in the subsequent drawings.

In the description of the present invention, it should be clarified that the location or position relations indicated by the terms “center”, “above” and “below”, “left”, “right” and “vertical”, “horizontal”, “inside” and “outside”, etc. are based on the location or position shown in the drawings, or those the products derived from the present invention are usually placed when they are in use. Such location or position are given only for the convenience of description and the simplification of the present invention, and are not intended to indicate or imply that the device or element referred to must have a particular orientation, or must be constructed and operated in a particular orientation. Therefore, they should not be construed as a limitation of the present invention. In addition, the use of the terms "first", "second", "third", etc., are only to distinguish descriptions and cannot be understood to indicate or imply relative importance.

In the description of the present invention, it is also necessary to note that, unless otherwise expressly specified and limited, the terms “setup”, “mounting”, “connection” and “coupling” should be understood in a broad sense, for example, they may be a fixed connection, a detachable connection, or an integrated connection; or may be a mechanical connection or an electrical connection; or can be direct connections indirect connections through any medium, or may be an internal connection of two components. For common technical staffs in the field, the specific meaning of the above terms in the present invention may be understood in a case by case manner.

The last point to be noted is: All the above embodiments are only referred to for the specific implementation of the present invention, which are used to explain the technical scheme of the present invention, rather than to pose any limit on it. The scope of protection of the present invention is not limited to this, although a detailed explanation is given for the present invention in reference to the foregoing embodiments. The common technical personnel of this field should understand: Within the scope of the technology disclosed by the present invention, any technical staff familiar with the field of technology can still modify or easily think of changes to the technical scheme recorded in the aforementioned embodiments, or replace part of the technical features with equivalent ones; and such modification, change or replacement will not result in the essence of the corresponding technical scheme being out of the scope of the technical scheme of the embodiments of the present invention, so they should be covered by the scope of protection of the present invention. Therefore, the protection scope of the present invention should be subject to the protection scope defined by the claims.

1. A production method of a vehicle support device, including:
making a symmetrical thread structure by pressing on both sides of a round steel to obtain a twin-screw rod;
making a through hole on the steel block so that the twin-screw rod can go through, and making internal threads matching with the twin-screw rod by pressing to obtain an adjusting block;
rotating the two adjusting blocks along both ends of the twin-screw rod to the middle of the same, so that the two adjusting blocks are mounted on both sides of the twin-screw rod;
making a movable frame, and fixing it with the two adjusting blocks; and
making a spanner, and fixing it to one end or the middle of the twin-screw rod.

2. The production method of the vehicle support device according to claim 1, wherein the steps of making a symmetrical thread structure by pressing on both sides of the round steel to obtain a twin-screw rod, include:
using a rotary clamping arm to hold the middle position of the round steel by clamping, and feeding the round steel into the pressing machine gradually along the direction from the end of one side of the round steel to the holding position, to complete the pressing of the forward threads on one side of the round steel; and
using the rotary clamping arm to drive the round steel to raise and rotate by 180°, and then feeding the round steel gradually into the pressing machine along the direction from the holding position on the other side to the end of the other side, to complete the pressing of the backward threads on the other side of the round steel and obtain a twin-screw rod.

3. The production method of the vehicle support device according to claim 1, wherein the steps of rotating the two adjusting blocks along both ends of the twin-screw rod to the middle of the same respectively, so that the two adjusting blocks are mounted onto both sides of the twin-screw rod, include:
placing the twin-screw rod on a fixing clamp, and using two rotary clamps on both sides of the fixing clamp to hold the adjusting blocks respectively, and making the two rotary frames move to both sides of the twin-screw rod and rotate at the same time.

4. The production method of the vehicle support device according to claim 1, wherein the steps of making a movable frame and fixing the movable frame with the two adjusting blocks include:
making an X-shaped shaft-coupling frame and an articulated frame, of which the X-shaped shaft-coupling frame includes an X-shaped shaft-coupling end in the middle and four movable shanks located on both sides of the X-shaped shaft-coupling end; and the articulated frame includes an articulated end and two movable ends on both sides of the articulated end; and
fixing the articulated ends of the two articulated frames respectively with the two adjusting blocks, and connecting the two movable ends of each articulated frame with the two movable shanks on the same side of the X-shaped shaft-coupling frame.

5. The production method of the vehicle support device according to claim 4, wherein the steps after fixing the articulated ends of the two articulated frames with the two adjusting blocks respectively, and connecting the two movable ends of each articulated frame with the two movable shanks on the same side of the X-shaped shaft-coupling frame respectively, include:
making a pressing plate, and pivotally connecting it to the four movable shanks of the X-shaped shaft-coupling frame through screws.

6. The production method of the vehicle support device according to claim 1, wherein the steps of making a movable frame and fixing it with the two adjusting blocks include:
making a movable prismatic frame, which comprises two horizontally-articulated ends and two longitudinally-articulated ends, and fixing the two horizontally-articulated ends with the two adjusting blocks respectively.

7. The production method of the vehicle support device according to claim 6, wherein the steps after making a movable prismatic frame which comprises two horizontally-articulated ends and two longitudinally-articulated ends, and fixing the two horizontally-articulated ends with the two adjusting blocks respectively, include:
making a pressing plate, and pivotally connecting it to the two longitudinally-articulated ends of the movable prismatic frame through screws.

8. The production method of the vehicle support device according to claim 6, wherein the steps after making a movable prismatic frame which comprises two horizontally-articulated ends and two longitudinally-articulated ends, and fixing the two horizontally-articulated ends with the two adjusting blocks respectively, include:
making a base component and a support component, and fixing the base component onto the longitudinally-articulated end at the bottom of the movable prismatic frame, and the support component onto the longitudinally-articulated end at the top of the movable prismatic frame.

9. The production method of the vehicle support device according to claim 5, wherein the steps of making a pressing plate include:
making a plate component by pressing, and performing arc stamping onto the plate component to obtain a curved plate component;
bending both sides of the curved plate component by 90° to obtain a bent curved plate component; and
making anti-skid bulges on the curved plate component by pressing to obtain a pressing plate.

10. A vehicle support device which is produced with the production method of the vehicle support device according to claim 1.
